(19) United States
(12) Patent Application Publication
(10) Pub. No.: US 2012/0127265 A1
(43) Pub. Date: May 24, 2012

(54) APPARATUS AND METHOD FOR STEREOSCOPIC EFFECT ADJUSTMENT ON VIDEO DISPLAY

(76) Inventors: Yi-Shu Chang, Hsin-Chu Hsien (TW); Yung-Chin Chen, Saratoga, CA (US); I-Ming Pao, Palo Alto, CA (US)

(21) Appl. No.: 13/299,306

(22) Filed: Nov. 17, 2011

Related U.S. Application Data
(60) Provisional application No. 61/414,906, filed on Nov. 18, 2010.

(51) Int. Cl. H04N 13/00

(52) U.S. Cl. 348/42; 348/E13.064

(57) ABSTRACT

The disclosure is regarding methods and apparatus for stereoscopic effect adjustment on video. The method for stereoscopic effect adjustment on video comprises receiving a 3D video, analyzing the 3D video for generating an analyzing result, and adjusting the 3D video according to a user preference input for stereoscopic effect and the analyzing result to generate a new 3D video. The apparatus for stereoscopic effect adjustment on video comprises a video analysis module, for receiving a 3D video and analyzing the 3D video to generate an analyzing result, and a 3D parameter adjustment module, for adjusting the 3D video according to a user preference input for stereoscopic effect and the analyzing result to generate a new 3D video.

### CROSS REFERENCE TO RELATED APPLICATIONS

This application claims the benefit of U.S. Provisional Application No. 61/414,906, filed on Nov. 18, 2010 and entitled “APPARATUS AND METHOD FOR STEREOSCOPIC EFFECT ADJUSTMENT ON VIDEO DISPLAY”, the contents of which are incorporated herein in their entirety.

### BACKGROUND OF THE INVENTION

1. Field of the Invention

The invention relates to methods and apparatus for adjustment on video, and more particularly to methods and apparatus for stereoscopic effect adjustment on video.

2. Description of the Prior Art

As the technologies in display panels advances, 3D display is becoming a mainstream product in display industry. 3D display discussed here includes 3D TV, 3D panels on laptop/portable video player, smartphone, and comes with varieties, e.g., polarized projection with passive polarized glasses, alternative frame sequencing with active shutter glasses, and auto stereoscopic display without the need for glasses.

3D video can be captured from stereoscopic photography, which records the images as seen from two (or multiple) perspectives. Computer-generated imagery is another source of 3D video. Current video standard for encoding 3D video includes H.264 MVC, which removes the redundancy between left and right channels to achieve compression goal. Compressed 3D bit streams are stored at server or Blue-ray discs. Users can access these 3D materials through cable/satellite network, or playback by 3D Blue-ray player. The 3D bit streams are decoded by set-top box or player and the decoded 3D video is fed to 3D TV/panel via communication channel, say HDMI. Several 3D formats in HDMI are proposed, e.g., field alternative, frame packing, line alternative, etc.

The original stereoscopic video for the left and right eyes are shot or rendered from different view angles and are compressed separately. The 3D Blu-ray player or 3D set top box can decode left and right video separately and send to TV to display. Current TV allows users to adjust video output based on their preference, for example contrast, saturation, and brightness, but the stereoscopic effect strength is fixed according the original input video.

### SUMMARY OF THE INVENTION

Therefore, one of the objectives of the present invention is to provide methods and apparatus for stereoscopic effect adjustment on video for users to adjust the 3D effect strength.

The present invention allows viewer to change the strength of the stereoscopic display effect for any 3D material. The method according to the present invention performs analysis on the input 3D video, detects the objects in the video, and establishes the depth profile and other information for each object. Based on users preference, the system then generate new depth map and new stereoscopic effect for each object and recreate the new 3D video for display.

The first aspect of the present invention is a method for stereoscopic effect adjustment on video, comprising: receiving a 3D video; analyzing the 3D video for generating a analyzing result; and adjusting the 3D video according to a user preference input for stereoscopic effect and the analyzing result to generate a new 3D video.

The second aspect of the present invention is an apparatus for stereoscopic effect adjustment on video, comprising: a video analysis module, for receiving a 3D video and analyzing the 3D video to generate a analyzing result; and a 3D parameter adjustment module, for adjusting the 3D video according to a user preference input for stereoscopic effect and the analyzing result to generate a new 3D video.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an apparatus for stereoscopic effect adjustment on video.

FIG. 2 shows an apparatus for stereoscopic effect adjustment on video according to one embodiment of the invention.

FIG. 3 illustrates parallax in stereoscopic view.

FIG. 4 illustrates relationship between parallax and object depth.

FIG. 5 illustrates process for objects movement in new video.

FIG. 6 illustrates a method for stereoscopic effect adjustment on video apparatus according to one embodiment of the invention.

### DETAILED DESCRIPTION

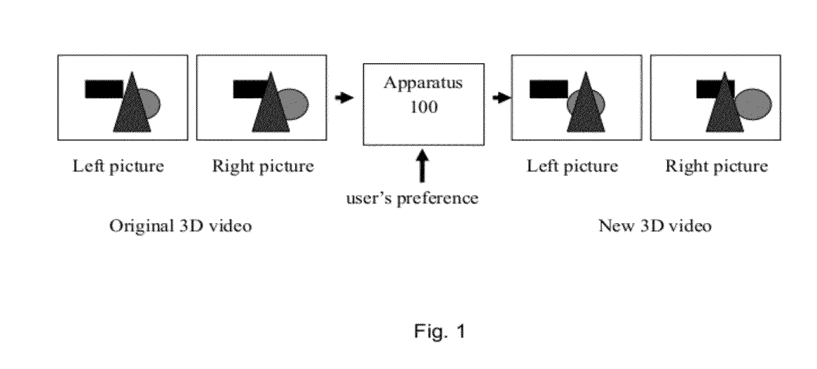

FIG. 1 illustrates an apparatus 100 for stereoscopic effect adjustment on video. Original 3D video and user's 3D preference are the input to the apparatus. Users can input their 3D effect preference by TV remote control, by computer/portable player's user interface. An example of user's input can be a scroll bar, and the user can slide the bar from weakest 3D strength to the strongest. The apparatus 100 analyzes the input video, and based on user's preference input and the analyzing result, a new 3D video is generated.

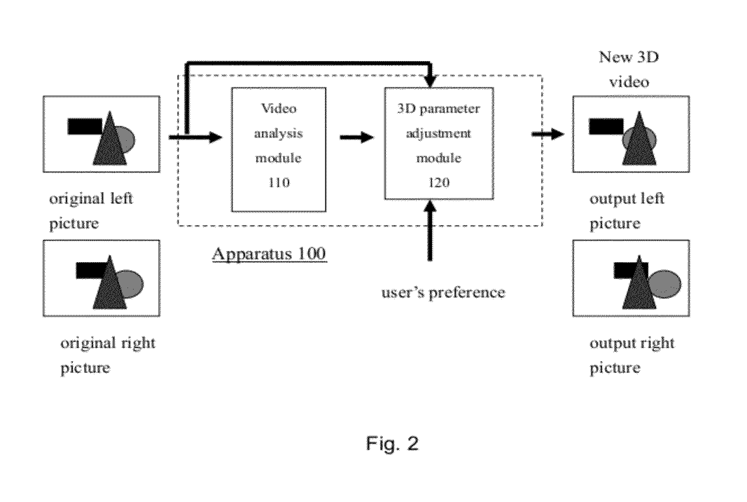

FIG. 2 shows the block diagram of the apparatus 100 for stereoscopic effect adjustment on video according to one embodiment of the invention. Video analysis module 110 receives a 3D video and analyzes the 3D video to generate an analyzing result. The video information to be analyzed can be, but not limited to, luminance, hue, pixel disparity, motion in the video as well as object position in left eye image and right eye image. Segmentation can be done so objects are detected in the video. Also the analyzed results from previous frames can be used to help on the analysis for the current frame. Object position, parallax, and depth information, and depth profile of the original 3D video including left eye image and right eye image are calculated and obtained as an analyzing result in this stage.

Then, a 3D parameter adjustment module 120 adjusts the original 3D video according to a user preference input for stereoscopic effect and the analyzing result to generate a new 3D video. 3D parameter adjustment (e.g. objects' depth) is done based on user's preference input for stereoscopic effect. Using original depth map, new depth map is generated according to user's choice. The 3D strength can also be combined with other adjustable features (ex: contrast, saturation, and brightness) to make the final picture on the display more vivid and pleasing. According to one embodiment of the present invention, it allows users to increase a first depth of a first object in the 3D video and decrease a second depth of a second object in the 3D video. For example, 3D parameter adjustment module 120 allows user to increase object depth in center region of the video or display while decrease object depth in other regions. 3D parameter adjustment module 120 also allows user to adjust a third depth of a third object in one region by a third percentage and adjusts the fourth depth in another region by a different fourth percentage to generate the new 3D video. But user's complicated preference input for stereoscopic effect will results in complicated calculation and operation in apparatus 100.

Next, the new 3D video is generated based on new depth map, post-processing (ex: filtering) can be performed to enhance the video quality.

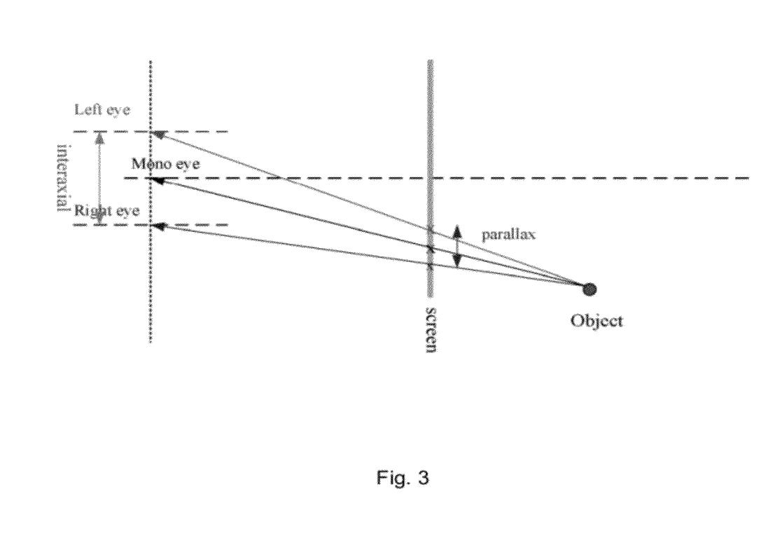

FIG. 3 shows how an object is projected to both eyes in stereoscopic view.

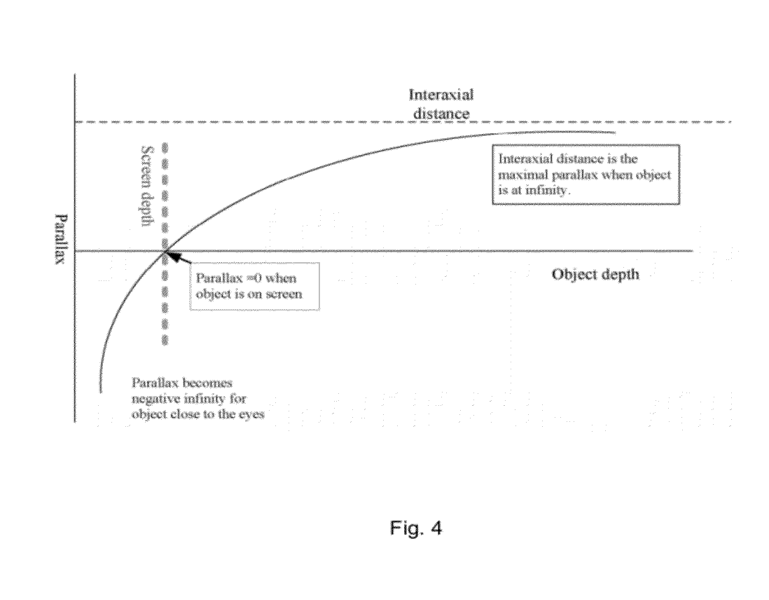

The same object seen by left eye and right eye will have a shift in the horizontal position as shown in FIG. 3. Parallax is the signed distance on the screen between the projected positions of the object in the left and right images. From the parallax and the average position of the object (i.e. projected position for the mono eye view), we can calculate the true position of the object in 3D space. As shown in FIG. 4, the parallax is zero if the object is located at the screen and the parallax can be negative if the object appears to be out of the screen (i.e., object is located between the screen and the eyes). When the object is at infinity, the parallax is close to the interaxial, the distance between two eyes.

According to one embodiment of the invention, one procedure for stereoscopic effect adjustment on video is illustrated as follows

The first step of one embodiment is to locate the positions of the same object in left and right eye images by the video analysis module 110.

The second step of one embodiment is to calculate the parallax for each object by the video analysis module 110. And then the video analysis module 110 can calculate the position of the object in 3D space, including object depth, for each object.

The third step of one embodiment is to calculate the new positions of the object based on user's preference input for stereoscopic effect by the 3D parameter adjustment module 120. We may move the position of the projected screen and we may move the positions of the objects so they appear to be closer to the screen or farther from the screen than the original video.

The fourth step of the invention is to reconstruct the image based on the new positions of the screen or objects.

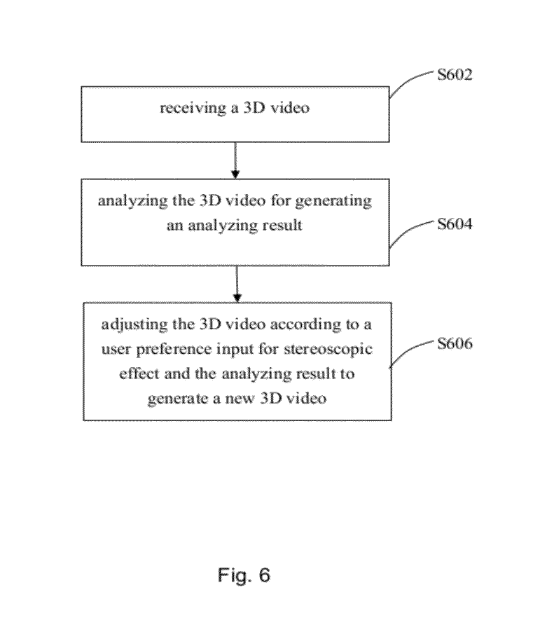

Next, please refer to FIG. 6, which shows a flowchart illustrating a method for stereoscopic effect adjustment on video according to one embodiment of the invention. Please note that, if the result is substantially the same, the steps are not required to be executed in the exact order shown in FIG. 6. In addition, the steps in FIG. 6 are not required to be executed sequentially, i.e., other steps can be inserted in between. The steps are detailed as follows:

Step 602: receiving a 3D video;

Step 604: analyzing the 3D video for generating an analyzing result; and

Step 606: adjusting the 3D video according to a user preference input for stereoscopic effect and the analyzing result to generate a new 3D video.

According to another embodiment of the invention, Step 606 comprises:

Step 608: adjusting a depth of an object in the 3D video to generate the new 3D video.

According to another embodiment of the invention, Step 608 comprises:

Step 610: locating the object in a left eye image and a right eye image; and

Step 612: obtaining a parallax of the object; wherein the depth of the object is adjusted according to the user preference input and the parallax.

According to another embodiment of the invention, Step 606 comprises:

Step 614: increasing a first depth of a first object in the 3D video and decreasing a second depth of a second object in the 3D video to generate the new 3D video.

According to another embodiment of the invention, Step 606 comprises:

Step 616: adjusting a first depth of a first object in the 3D video by a first percentage and adjusting a second depth of a second object in the 3D video by a second percentage to generate the new 3D video, wherein the first percentage is not equal to the second percentage.

Following is one embodiment of the invention to implement the video analysis module 110 and the 3D parameter adjustment module 120. But the present invention is not limited to only this implementation. The present invention can use MEMC (motion estimation and motion compensation) to analyze the input 3D video and reconstruct a new 3D video image according to a user preference input for stereoscopic effect and the analyzing result.

The motion estimation (ME) is the process to find a motion vector (MV) to represent the movement of an object between two frames. The most common motion search algorithm is block based search. The present invention can partition an entire picture into fixed sized blocks, such as 8×8 or 16×16, and then search for a best match between two frames based on a search criterion. Some commonly used criteria includes SAD (sum of absolute differences), MSE (mean square error), or MAD (mean absolute distortion).

We pick one of the images as the reference picture, say, picture for the left eye, and partition the image into small blocks. Then we search the best match (motion vector) from the image for right eye, i.e. target picture. Unlike conventional motion estimation, the search would focus on horizontal direction. As shown in the FIG. 4, the search range for parallax is limited and asymmetric. The positive motion won't be more than interaxial distance but the negative value can be up to the image boundary.

Once the motion vector is found, we can estimate the object position viewed by mono eye as shown in FIG. 3 by averaging the positions of the object in left and right images. With known distance between screen and viewer, we can calculate the object depth.

Then we can scale the object depth based on viewer's preference and re-calculate the new parallax and obtain the new object depth.

The next stage of work is the reconstruction of the new images. We will fetch the original block, move to the new position based on the new parallax value, and paste it back for both left and right images respectively.

Proper pixel processing is necessary to make new 3D video look nature. For example, filtering (filter is not shown) can be applied to make object boundaries smoother.

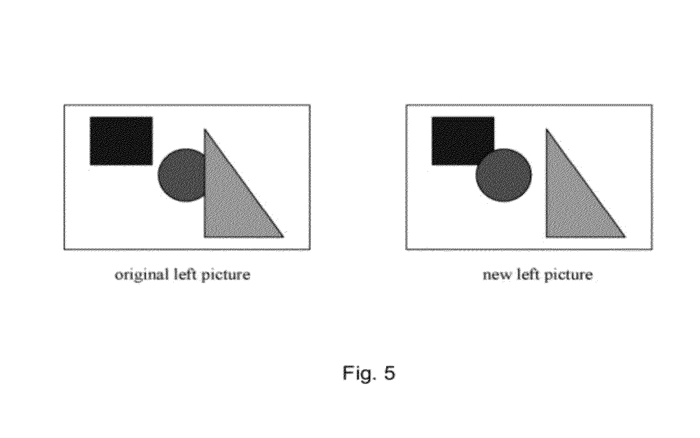

Objects in the new video (including the new left and right images) will be moved to new locations based on their new updated depths. This means there will be covered and uncovered areas in the new 3D video and need proper care and is illustrated in FIG. 5. We explain the uncover case first. Relative to the square and triangle, the circle is moved to a new location in the new left picture as shown in FIG. 5. Some part of the circle not seen in original left picture (covered by the triangle) is revealed in the new left picture, and the apparatus 100 can retrieve/generate the pixels in this revealed area from previous frames, future frames, and the frame from the other eye (in this case, the right picture).

The other case is the cover area. For example, in FIG. 5, the circle is moved to its new position based on updated depth information and the circle will overlap with the rectangle in the new left picture. The problem is how do we decide which object is on top and which one is on the back (in FIG. 5, the circle is on the foreground and the rectangle is at the background). The apparatus 100 provides the solution and can find out the position, including the depth, for each object in the video analysis stage. Therefore, when the objects are being placed back during reconstruction stage, the apparatus 100 has the knowledge of the order of objects and can put them back based on their depth information when there are overlapping between objects.

Those skilled in the art will readily observe that numerous modifications and alterations of the device and method may be made while retaining the teachings of the invention.

What is claimed is:

1. A method for stereoscopic effect adjustment on video, comprising:
receiving a 3D video;
analyzing the 3D video for generating an analyzing result; and
adjusting the 3D video according to a user preference input for stereoscopic effect and the analyzing result to generate a new 3D video.

2. The method for stereoscopic effect adjustment on video of claim 1, wherein the step of adjusting the 3D video according to the user preference input for stereoscopic effect and the analyzing result to generate the new 3D video comprises:
adjusting a depth of an object in the 3D video to generate the new 3D video.

3. The method for stereoscopic effect adjustment on video of claim 2, wherein the step of adjusting the depth of the object in the 3D video to generate the new 3D video comprises:
locating the object in a left eye image and a right eye image; and
obtaining a parallax of the object;
wherein the depth of the object is adjusted according to the user preference input and the parallax.

4. The method for stereoscopic effect adjustment on video of claim 1, wherein the step of adjusting the 3D video according to the user preference input for stereoscopic effect and the analyzing result to generate the new 3D video comprises:
increasing a first depth of a first object in the 3D video and decreasing a second depth of a second object in the 3D video to generate the new 3D video.

5. The method for stereoscopic effect adjustment on video of claim 4, wherein the first object and the second object belong to different regions of the 3D video.

6. The method for stereoscopic effect adjustment on video of claim 1, wherein the step of adjusting the 3D video according to the user preference input for stereoscopic effect and the analyzing result to generate the new 3D video comprises:
adjusting a first depth of a first object in the 3D video by a first percentage and adjusting a second depth of a second object in the 3D video by a second percentage to generate the new 3D video, wherein the first percentage is not equal to the second percentage.

7. An apparatus for stereoscopic effect adjustment on video, comprising:
a video analysis module, for receiving a 3D video and analyzing the 3D video to generate an analyzing result; and
a 3D parameter adjustment module, for adjusting the 3D video according to a user preference input for stereoscopic effect and the analyzing result to generate a new 3D video.

8. The apparatus for stereoscopic effect adjustment on video of claim 7, wherein the analyzing result comprises a depth of an object in the 3D video and the 3D parameter adjustment module adjusts the 3D video according to the depth of the object and the user preference input to generate the new 3D video.

9. The apparatus for stereoscopic effect adjustment on video of claim 8, wherein the analyzing result comprises a left position of an object in a left eye image, a right position of the object in a right eye image, and a parallax of the object, and wherein the 3D parameter adjustment module adjusts the depth of the object according to the user preference input and the parallax.

10. The apparatus for stereoscopic effect adjustment on video of claim 7, wherein the analyzing result comprises a first depth of a first object and a second depth of a second object in the 3D video, and wherein the 3D parameter adjustment module adjusts the 3D video by increasing the first depth and decreasing the second depth according to the user preference input to generate the new 3D video.

11. The apparatus for stereoscopic effect adjustment on video of claim 10, wherein the first object and the second object belong to different regions of the 3D video.

12. The apparatus for stereoscopic effect adjustment on video of claim 7, wherein the analyzing result comprises a first depth of a first object and a second depth of a second object in the 3D video, and wherein the 3D parameter adjustment module adjusts the first depth by a first percentage and adjusts the second depth by a second percentage to generate the new 3D video, wherein the first percentage is not equal to the second percentage.
